(19) United States
(12) Patent Application Publication
(10) Pub. No.: US 2026/0364901 A1
(43) Pub. Date: Nov. 19, 2026

(54) SEALANT SYSTEM

(71) Applicant: Continental Reifen Deutschland GmbH, Hannover (DE)

(72) Inventors: Florian Schlosser, Barsinghausen (DE); Rainer Detering, Neustadt am Rübenberge (DE); Zakariaa EI Yamlahi, Hannover (DE)

(73) Assignee: Continental Reifen Deutschland GmbH, Hannover (DE)

(21) Appl. No.: 19/126,459

(22) PCT Filed: Oct. 25, 2023
(86) PCT No.: PCT/DE2023/200216

§ 371 Date: May 1, 2025

(30) Foreign Application Priority Data
Nov. 3, 2022 (DE) 10 2022 211 603.8

(51) Int. Cl. B29C 73/02

(52) U.S. Cl. CPC B29C 73/025

(57) ABSTRACT

A sealant system including: a sealant container having a container interior which is accessible by way of a container opening lying at the end of a container neck, and a container closure, which has a first fluid channel extending through the container closure, and a second fluid channel extending through the container closure. The container closure has a fastening region. On the container neck is an encircling first fastening elevation, which tapers in the direction of the container opening. On the fastening region is an encircling second fastening elevation, which tapers in a pressing direction. The container closure can be disposed on the container opening by pressing the container closure onto the sealant container, thereby elastically deforming the fastening region and/or the container neck. A form-fitting connection is formed by the mutual engagement of the first fastening elevation and the second fastening elevation.

The invention relates to a sealant system and to a container closure for closing a container opening of a sealant container, which lies at the end of a container neck, in a corresponding sealant system. Disclosed is moreover a method for producing a corresponding sealant system, or a corresponding container closure, and a breakdown assistance set comprising a corresponding sealant system, and a method for sealing a damaged vehicle tire using a corresponding breakdown assistance set.

Sealants for sealing leaking components are typically used in many fields of engineering, such as in the tire and vehicle industry, for example. In most cases, sealants are provided in a viscous form in so-called sealant systems, developing their sealing effect only upon leaving this sealant system, for example due to contact with air and/or the substrate to be sealed. Sealant systems are widely used in particular in the tire and vehicle industry, for example in the context of breakdown assistance sets for at least temporarily repairing damaged vehicle tires.

Such sealant systems for storing sealants typically have to meet particularly high requirements because they have to enclose a sealant to be stored in such a manner that the latter does not prematurely cure, thus having to prevent sealant from unintentionally escaping, on the one hand, and however have to enable a rapid and simple supply in the event of use, an operation which-in particular in the case of breakdown assistance sets-has also to be performed by the ordinary person and/or without suitable tools.

Accordingly, sealant systems have to be closed in a fluid-tight manner after being filled with sealant, so as to protect the sealant from environmental influences, in particular also in the event of shocks and vibrations. The closure of the sealant system is opened by applying suitable measures only when the sealant system is used by a user in order to dispense the sealant, this in most instances being facilitated or caused by applying an external pressure and by forcing the sealant out of the sealant system.

After filling the sealant system with sealant, and prior to the intended use of the latter, it is to be ensured in many cases that the container of the sealant system containing the sealant cannot be reopened too easily, in particular in order to prevent any incorrect use of the sealant, for example by children. Moreover, a closure of the sealant system is ideally to be largely “pressure tight” so that a reliable closure is guaranteed even at a positive pressure prevalent in the container. This is also particularly important because the dispensing of the sealant in the later use in the sealing method is in many cases effected in that one or a plurality of fluid channels disposed in the closure are opened by being impinged with pressure, in that seals or separate sealing elements used for the closure are opened in such a way that a sealant can exit the sealant system through at least one of those opened fluid channels, whereby it is important that the positive pressure does not force out the entire container closure.

In this context, in particular screw closures, which are in most instances relatively easy to produce in practice and can optionally be used conjointly with an additional sealing element such as a sealing ring in order to reliably close corresponding sealant systems, are known for closing sealant systems in the prior art. However, such screw closures are also considered disadvantageous in many cases, in particular with a view to the risk of incorrect uses of sealants, which exists due to the possibility of reversibly opening screw closures in a non-destructive manner. Accordingly, an anti-twist device is often provided in screw closures, so that the closure of the sealant system cannot be easily opened and the sealant is protected against incorrect use and also from environmental influences. However, the use of additional safety devices is in many cases associated with additional components and/or an additional complexity in terms of production as well as a corresponding investment in costs and time.

It is considered disadvantageous in particular that the production of corresponding sealant systems in production machines is often an inefficient process which is difficult to control and/or automate, because a screwing movement, i.e. screwing the closure to the container of the sealant system, typically requires a lot of time, and the required tightening torque is difficult to control. Moreover, corresponding container closures also have to meet additional use-related requirements, wherein for example in the case of “upside down” bottles there has to be a suitable receptacle on the compressor, or a stand, during operation, as a result of which the freedom of design in terms of construction may be reduced.

Additional prior art pertaining to the technical background is disclosed in, for example, EP 2123432 A1 and 3099473 A1.

It was the primary object of the present invention to eliminate or at least alleviate the above-described disadvantages of the prior art.

In particular, it was the object of the present invention to specify a sealant system and a corresponding container closure by way of which the closure of sealant containers can be simplified in terms of production. It was a desirable target herein that the sealant system to be specified should nevertheless be able to be particularly reliably closed by the simplified container closure, so that the risk of undesirable opening of the sealant system would be reduced in comparison to the prior art.

It was an additional object of the present invention that the production of the sealant system to be specified should be possible in a particularly time-efficient and cost-efficient manner. It was a desirable target herein that the requirement in terms of additional components for implementing an anti-twist device should be minimized in comparison to the prior art.

It was an additional object of the present invention to provide a corresponding container closure for the sealant system to be specified, by way of which the advantageous closure can be implemented.

It was a secondary object of the present invention to specify a method for producing a corresponding sealant system and/or an associated container closure. It was a desirable target herein that quality control of the container closure should be possible in a particularly simple manner.

Moreover, it was a secondary object of the present invention to provide a breakdown assistance set having one or a plurality of corresponding sealant systems, and a method for sealing a damaged vehicle tire using such a breakdown assistance set.

The inventors have now recognized that the above-described objects can surprisingly be achieved when in a sealant system the container neck of a sealant container, and a container closure of the sealant system, are embodied in such a manner that a form-fitting connection in the manner of a click closure can be formed therebetween by way of specific, mutually complementary, fastening elevations when the container closure is pressed against the container neck, as defined in the claims. In other words, for achieving the above objects, the container closure is fastened to the bottle with a click closure, for which purpose an undercut is provided on the opening in the container closure, and a complementary convexity is provided on the bottle neck, so that when the container closure is attached and pressed down, the undercut slides over the convexity on the bottle neck and latches behind the latter, so that it is no longer possible to easily release the closure.

In this way, a sealant system having a simplified closure can advantageously be obtained, which reliably minimizes the risk of undesirable opening and can be implemented in a particularly time-efficient and cost-efficient manner in terms of production.

The above-mentioned objects are thus achieved by the subject matter of the invention as defined in the claims. Preferred design embodiments according to the invention are derived from the dependent claims and the explanations hereunder.

Embodiments which are designated below as being preferred are combined in particularly preferred embodiments with features of other embodiments designated as being preferred. Especially preferred, therefore, are combinations of two or more of the embodiments designated below as being particularly preferred. Likewise preferred are embodiments in which a feature of one embodiment, designated to some extent as being preferred, is combined with one or more further features of other embodiments which are designated to some extent as being preferred. Features of preferred container closures, breakdown assistance sets and methods are derived from the features of preferred sealant systems.

The invention relates to a sealant system, in particular a sealant system for use when sealing vehicle tires, comprising:
a) a sealant container comprising a container interior for receiving sealant, wherein the container interior is accessible by way of a container opening lying at the end of a container neck; and
b) a container closure, wherein the container closure comprises a first fluid channel extending through the container closure, and a second fluid channel extending through the container closure, wherein the container closure comprises a fastening region;
wherein disposed on the container neck is an encircling first fastening elevation, wherein the first fastening elevation tapers in the direction of the container opening;
wherein disposed on the fastening region is an encircling second fastening elevation, wherein the second fastening elevation tapers in a pressing direction A;
wherein the sealant system is specified in such a way that the container closure can be disposed on the container opening by pressing the container closure along the pressing direction A onto the sealant container, thereby at least partially elastically deforming the fastening region and/or the container neck; and
wherein the sealant system is specified in such a way that, when disposing the container closure on the container opening, a form-fitting connection is formed by the mutual engagement of the first fastening elevation and the second fastening elevation.

The fundamental functional mode of sealant systems, and the use of the latter in breakdown assistance sets, are known to the person skilled in the art, based on his/her technical knowledge. Accordingly, the person skilled in the art understands that a sealant system according to the invention has to be suitable for storing sealants in a fluid-tight manner, as well as for later dispensing of sealants, wherein the sealant system in terms of the fundamental design embodiment can be adapted to the requirements of the sealant to be received by the person skilled in the art, for example in terms of the material of the sealant container.

For receiving sealant, the sealant system according to the invention comprises a sealant container having a container interior which is accessible by way of a container opening lying at the end of a container neck, the container interior sometimes also being referred to as the sealant bottle. Corresponding to the understanding of a person skilled in the art, the container neck of the sealant container is considered in practice to be the portion of the sealant container which is reduced in terms of the diameter in comparison to the sealant container and which at its end opens directly into the container opening. A sealant system according to the invention is relevant to substantially all embodiments in the field of sealing vehicle tires, wherein the container interior has a volume in the range from 0.05 to 10 l, preferably in the range from 0.1 to 5 l, particularly preferably 0.2 to 2.5 l, most particularly preferably 0.2 to 1.25 l.

The person skilled in the art understands that the sealant does not inevitably have to be part of the above-defined sealant system according to the invention, which can also be provided to a sealant manufacturer as a (re-)fillable storage vessel by a producer, for example. In a particularly preferred embodiment however, the sealant system according to the invention already comprises the sealant, so that said sealant system can be used directly when sealing vehicle tires. Compositions which are suitable for use as a sealant, in particular for sealing vehicle tires, are known to the person skilled in the art from the prior art, and are commercially available from various suppliers. Accordingly, a sealant system according to the invention is preferred, additionally comprising in the container interior a sealant, preferably a sealant for sealing damaged vehicle tires. A damaged vehicle tire in this context is understood to be in particular a vehicle tire having comparatively small holes in the tread, such as can be caused by nails or similar, for example.

The person skilled in the art understands that the sealant container in practice will be fluid-tight in most cases, with the exception of the container opening, so that viscous sealant or other fluids can enter or exit only by way of the container opening.

In principle however, it is at least theoretically possible to equip the sealant container with a plurality of container openings which in this instance are each to be closed. However, in most cases it is advantageous to provide only a single container opening in order to increase the stability of the sealant container and to facilitate the production of corresponding containers, on the one hand, and to simplify the fluid-tight closure of the container interior, on the other hand. Therefore, a sealant system according to the invention, wherein the container interior is accessible by way of only one container opening, is relevant in most cases.

The sealant system according to the invention moreover comprises a container closure which is specified to be disposed on the container neck of the sealant container in such a way that the container opening is closed, wherein it is preferred in the presence of a sealant in the interior that the container closure also actually closes the sealant container in a fluid-tight manner. The container closure herein comprises according to the invention a fastening region which will be described in more detail hereunder. To this extent, an example is a sealant system according to the invention, wherein a sealing element, preferably a sealing ring, is disposed between the container closure and the sealant container.

In the later use in a sealing method, for example for sealing vehicle tires, a sealant which is disposed in the sealant system is in most cases conveyed through the container closure, which previously closed in a fluid-tight manner, and through fluid channels opened in the method, out of the container opening of the sealant system by an external force acting thereon. In many cases, in particular in the field of tire repair, this external force acting thereon is caused or facilitated by introducing a further fluid, in particular compressed air.

In order to enable this functionality, i.e. the introduction of a fluid and the evacuation of the sealant, the container closure of the sealant system according to the invention comprises a specific fluid conducting system.

According to the invention, the container closure specifically has a first fluid channel and a second fluid channel. Expediently, the fluid channels will be closed in a fluid-tight manner until the sealant system according to the invention is used, so as to minimize the risk of sealant disposed in the container interior escaping prior to the sealing method. According to the invention, the fluid channels extend through the container closure in such a way that the container interior in the state closed by the container lid would be accessible only by way of the first fluid channel and the second fluid channel if those were not closed by corresponding sealing elements because the latter had already been opened by suitable measures. Therefore, a sealant system according to the invention is relevant in most cases, wherein the container closure comprises one or a plurality of sealing elements for sealing the first fluid channel and/or the second fluid channel, preferably the first fluid channel and the second fluid channel, in a fluid-tight manner, wherein the sealant system is preferably specified in such a way that the container closure upon disposal on the container opening closes the container opening in a fluid-tight manner until the sealing elements are opened by suitable measures.

The sealant system according to the invention will be operated in the later sealing method in most cases in such a manner that a sealant disposed in the container interior is forced out of the sealant container when applying a gas pressure by way of one of the two fluid channels of the container closure, so that said sealant can be directed by way of an additional line into the vehicle tire to be sealed, for example. In practice, upon opening the sealing elements, compressed air can be directed into the first fluid channel, for example, so that the introduced compressed air subsequently displaces a sealant disposed in the container interior in such a manner that the sealant can be directed, for example via a hose, into the object to be sealed, for example a damaged vehicle tire. In other words, this is a sealant system according to the invention, wherein the sealant system is specified in such a way that, upon opening the sealing elements in the fluid channels, a working fluid can enter the container interior through the first fluid channel, so as to displace a sealant disposed in the container interior out of the container interior by way of the second fluid channel.

In the later practical use, the outward-pointing ends of the first fluid channel and of the second fluid channel will accordingly have to be connected to fluid lines in many cases in order to conduct fluids. For example, threaded connections can be used for connecting the fluid lines to the fluid channels. Alternatively, tube clips, i.e. tube ends on which a hose can be fastened, optionally additionally with a hose clip, are also conceivable. Accordingly, a sealant system according to the invention is preferred, wherein the first fluid channel comprises a first connector for a fluid line, wherein the first connector preferably comprises a tube clip or a thread, preferably a thread. A sealant system according to the invention, wherein the second fluid channel comprises a second connector for a fluid line, wherein the second connector preferably comprises a tube clip or a thread, preferably a thread, is also relevant for most cases.

The sealant system according to the invention is advantageously not limited in terms of the specific design embodiment of the fluid channels, wherein the dimensions of the latter in practice will in particular be suitably adapted to the dimensions of the container closure and the structural design embodiment of the devices used in the sealing method. An example is a sealant system according to the invention, wherein the first fluid channel has a length in the range from 10 to 50 mm, preferably in the range from 25 to 35 mm, and/or wherein the first fluid channel has a mean diameter in the range from 2 to 35 mm, preferably in the range from 3 to 8 mm. Likewise, an example is additionally or alternatively a sealant system according to the invention, wherein the second fluid channel has a length in the range from 10 to 50 mm, preferably in the range from 15 to 25 mm, and/or wherein the second fluid channel has a mean diameter in the range from 2 to 35 mm, preferably in the range from 3 to 8 mm.

The sealant system according to the invention can advantageously be efficiently adapted to the most varied application requirements, so that an operation of the sealant system according to the invention can take place upright as well as “upside down”, for example. In other words, this means that the sealant system according to the invention can be conceived in such a way that the discharge of sealant counter to the direction of gravity as well as in the direction of gravity is made possible if required. For this purpose, in an upright operation, i.e. when a sealant disposed in the container interior has to be conveyed at least partially counter to the direction of gravity in order to exit the sealant system through the container opening, it is necessary to provide a so-called riser on at least one of the fluid channels, preferably the fluid channel through which the sealant is conveyed outside. The term riser is known to the person skilled in the art in the context of fluids, and refers to a pipe or a hose through which fluids can rise, for example due to the action of external pressure. In an “upside down” operation of the sealant system according to the invention, i.e. when a sealant disposed in the container interior is conveyed substantially along the direction of gravity, such a riser is however not required for the fluid channel provided for the discharge. Accordingly, a sealant system according to the invention, wherein the second fluid channel is designed as a riser is preferable for the later upright use, wherein the end of the second fluid channel pointing in the direction of the container interior extends into the container interior preferably by 0.85*H or more, preferably by 0.9*H or more, particularly preferably by 0.95*H or more, where H is the height of the container interior.

A sealant system according to the invention is preferable for the later “upside down” operation, wherein the end of the second fluid channel pointing in the direction of the container interior extends into the container interior by 0.15*H or less, preferably by 0.1*H or less, particularly preferably 0.05*H or less, wherein the end of the first fluid channel pointing in the direction of the container interior extends into the container interior preferably by 0.05*H or more, particularly preferably 0.1*H or more, most particularly preferably 0.15*H or more, where H is the height of the container interior.

Even when at least in theory potential overpressure safety devices can be provided, according to the opinion of the inventors it is expedient for substantially all embodiments when the first fluid channel and the second fluid channel are spatially completely separated from one another, and thus cannot be short-circuited in other words. Accordingly, a sealant system according to the invention, wherein the first fluid channel and the second fluid channel are mutually separated in the container closure is preferable for substantially all embodiments. According to the opinion of the inventors, two embodiments are fundamentally advantageous in this case. On the one hand, the first fluid channel and the second fluid channel can be disposed next to one another, or orthogonally to one another, in the container closure. Alternatively, a coaxial arrangement of the fluid channels is possible and also preferable in many cases.

According to the invention, an encircling first fastening elevation tapering in the direction of the container opening is disposed on the container neck of the sealant container, and an encircling second fastening elevation tapering in a pressing direction A is disposed on the fastening region of the container closure. The person skilled in the art understands that the first fastening elevation, proceeding from the end of the container neck pointing in the direction of the sealant container, correspondingly tapers toward the end of the container neck pointing in the direction of the container opening.

The pressing direction A is the direction in which the container closure is attached to the container neck, wherein it is not defined thereby in accordance with the understanding of the person skilled in the art that the container closure actually has to be moved when closing, so that pressing the container neck onto the container closure is also possible, which according to the definition would be performed counter to the pressing direction A. In practice, the pressing direction A, and correspondingly the taper of the second fastening elevation, will thus be substantially counter to the tapering direction of the first fastening elevation.

According to the invention, the container closure and the sealant container can be connected in a form-fitting manner due to a corresponding basic design of the sealant system, in that the two tapering fastening elevations mutually engage when the container closure is pressed along the pressing direction A onto the sealant container. According to the invention, the fastening region of the container closure and/or the container neck are/is at least partially elastically deformed. In this context, the person skilled in the art understands that the question of which one of the components will be deformed during closing depends substantially on the structural design embodiment of the components, wherein regions with a lesser material thickness and/or of flexible materials are in most instances more easily and thus more intensely deformed than regions with thick walls and/or regions of particularly stiff materials. A sealant system according to the invention is preferable, wherein the sealant system is specified in such a way that the container closure can be disposed on the container opening by pressing the container closure along the pressing direction A onto the sealant container, thereby substantially completely elastically deforming the fastening region and/or the container neck.

The design embodiment according to the invention, which is also referred to as a click closure by the inventors, is according to the opinion of the inventors particularly robust and particularly advantageous in particular with a view to securing corresponding closures in relation to unintentional opening. Unintentional opening of the closed sealant system can specifically be particularly reliably avoided in this way, because the return of the fastening elevations to their initial position after the elastic deformation, in other words the latching of the click closure, advantageously takes place in such a manner that the form-fitting connection of the fastening elevations can prevent unintentional re-opening of the click closure even under high extraction forces. Advantages herein are derived in particular in comparison to a conventional screw closure which for avoiding unintentional opening has in most instances to be equipped with an anti-twist device, so that the production complexity can be significantly reduced by dispensing with anti-twist devices.

According to the opinion of the inventors, a corresponding click closure between the components can be produced with a particularly minor complexity in terms of production.

In order to simplify the assembling of the closure, i.e. the production of the form-fitting connection between the container closure and the sealant container, it can be advantageous according to the opinion of the inventors to subdivide the container closure into a plurality of segments, so that the second fastening elevation, or the segments of the second fastening elevation, is/are more mobile during the assembly procedure.

The inventors have found that a corresponding click closure is quick and easy to handle when in use, in particular also in the mechanized, i.e. at least partially automated, production, so that pressing the container closure onto the sealant container of the sealant system according to the invention is able to be carried out in a particularly time-efficient manner, for example, in particular in comparison to a screw closure which typically requires the setting of specific torques and is correspondingly more difficult to handle in production machines. Therefore, a sealant system according to the invention is preferable for substantially all embodiments, wherein the container neck does not comprise a thread, and/or wherein the fastening region does not comprise a thread.

The person skilled in the art understands that the term “encircling” does not preclude that the fastening elevations are interrupted and are in each case formed by a plurality of fastening sub-elevations. Instead, it can even be considered an advantage of the sealant system according to the invention that neither the first fastening elevation nor the second fastening elevation in terms of their structural embodiment are limited to integral elevations. In this context, the encircling fastening elevations within the scope of the present invention can for example also be designed as interrupted encircling fastening elevations. For example, for simplifying the assembling of the closure, i.e. the production of the form-fitting connection between the container closure and the sealant container, it can be advantageous in the opinion of the inventors to subdivide the container closure into a plurality of segments so as to improve the deformation capability in such a way that the second fastening elevation, or the segments of the second fastening elevation, is/are more mobile during the assembly procedure and can be guided more easily over the first fastening elevation. An example is thus a sealant system according to the invention, wherein the first fastening elevation is a continuous encircling fastening elevation, or wherein the first fastening elevation comprises two or a plurality of partially encircling fastening sub-elevations. Likewise, an example is a sealant system according to the invention, wherein the second fastening elevation is a continuous encircling fastening elevation, or wherein the second fastening elevation comprises two or a plurality of partially encircling fastening sub-elevations.

For most of the applications it is preferred in the sealant system according to the invention to design the fastening elevations so as to be complementary but substantially of identical type in order to achieve an ideally positive form-fit. Accordingly, a sealant system according to the invention is preferred, wherein the height of the first fastening elevation H₁ and the height of the second fastening elevation H₂ differ by less than 30%, preferably by less than 20%, particularly preferably by less than 10%, most particularly preferably substantially not at all. An example is a sealant system according to the invention, wherein the first fastening elevation and/or the second fastening elevation, preferably the first fastening elevation and the second fastening elevation, have a wedge-shaped cross section.

The closure system of the sealant system according to the invention can advantageously be embodied in different ways, as a result of which a high degree of structural flexibility is advantageously achieved. In the process, the design embodiment of the fastening region and the orientation of the fastening elevations are in particular influenced.

A first design embodiment is derived in that the container closure by way of a fastening collar encloses the container neck of the sealant container at least in portions, so that the lateral walls of the fastening collar upon attaching externally flank the container neck, as would also be the case in customary screw-cap bottle closures. The second fastening elevation here is expediently directed inward, so that the second fastening elevation is guided past the first fastening elevation when pressing on the radially outer side. Accordingly, a sealant system according to the invention is preferred, wherein the fastening region comprises an encircling fastening collar, preferably a continuously encircling fastening collar, wherein the encircling second fastening elevation is disposed on the fastening collar, preferably on the side pointing radially inward. Accordingly, a sealant system according to the invention is also preferred, wherein the first fastening elevation is disposed on the radially outer side of the container neck, and wherein the second fastening elevation is disposed on the radially inner side of the fastening region.

An alternative is a design embodiment in which the container closure, similar to a cork, can be partially inserted into the container opening, so that said container closure is enclosed by the sealant container at least in portions. The second fastening elevation herein expediently points outward, so that the second fastening elevation is guided past the first fastening elevation on the radially inner side. Alternatively, a sealant system according to the invention is thus preferred, wherein the fastening region comprises a central fastening plug, wherein the encircling second fastening elevation is disposed on the fastening plug, preferably on the side pointing radially outward. Accordingly, a sealant system according to the invention is preferred, wherein the first fastening elevation is disposed on the radially inner side of the container neck, and wherein the second fastening elevation is disposed on the radially outer side of the fastening region.

In this context, the inventors propose that, independently of the design embodiment of the fastening region, an ideally steep undercut can be provided by way of which the mutual engagement of the fastening elevations is particularly intensely facilitated, so that not only can pressing on the container closure take place particularly easily, but also an unintentional extraction of the container closure due to interlocking is additionally impeded. In this context, for example, cross-sectional shapes of the fastening elevations are preferred, in which in a triangular basic shape the angle lying between the side facing away from the taper and the side resting on the respective component is larger than 90°, so that a design embodiment in the manner of a tip of an arrow is obtained. Therefore, a sealant system according to the invention is preferred, wherein the first fastening elevation has a triangular cross section, wherein the triangular cross section between the side facing away from the taper and the side resting on the container neck preferably has an angle in the range from 80° to 135°, particularly preferably in the range from 85° to 120°, most particularly preferably in the range from 90° to 105°. Likewise, a sealant system according to the invention is preferred, wherein the second fastening elevation has a triangular cross section, wherein the triangular cross section between the side facing away from the taper and the side resting on the fastening region preferably has an angle in the range from 80° to 135°, particularly preferably in the range from 85° to 120°, most particularly preferably in the range from 90° to 105°.

The inventors propose that the sealant system for an optimal combination of a simple closure and impeded reopening should be conceived in such a way that the force required for closing the closure is significantly less than the force required for opening the closure, this—thanks to the design embodiment according to the invention—being able to be set advantageously, in particular by the structural design embodiment of the fastening elevations and the selection of material. In a particularly preferred embodiment, the force required for opening the closure of the sealant system is so high that a user cannot achieve opening without additional aids such that an incorrect use can in particular be prevented. Therefore, a sealant system according to the invention is preferred, wherein the sealant system is specified in such a way that the first fastening elevation and the second fastening elevation can slide past one another when pressing the container closure along the pressing direction A onto the sealant container when using a pushing pressure P₁ and that, as a consequence of the mutual engagement of the first fastening elevation and the second fastening elevation, a form-fitting connection is caused, in which the first fastening elevation and the second fastening elevation cannot slide past one another when using an extraction pressure P₂, wherein the extraction pressure P₂ is higher than the pushing pressure P₁, preferably a factor of 5 or more, particularly preferably of 10 or more, most particularly preferably of 100 or more. In other words, the pushing pressure P₁ corresponds to the mechanical pressure which has to be applied in order to produce the form-fitting connection between the container closure and the sealant container, while the extraction pressure P₂ is the pressure that would be required in order to cancel and/or destroy the form-fitting connection.

It can be considered an advantage of the sealant system according to the invention that neither the sealant container nor the container closure are fundamentally limited in terms of the materials used in production. In this context, the person skilled in the art however understands that the selection of material should be performed in such a way that in view of the respective structural design embodiment of the components, at least one of the components has a sufficient deformation capability in order to enable the form-fit to be formed. When using a very stiff container neck, a sufficient flexibility of the container closure should be correspondingly set by way of the structural design embodiment and/or material selection. The inventors propose that particularly advantageous characteristics can be obtained in terms of production, when the components are formed from a thermoplastic plastics material. As a result, not only are particularly time-efficient and cost-efficient production methods such as injection molding accessible, but the deformation capability can be influenced by applying higher temperatures if required. Accordingly, a sealant system according to the invention is preferred, wherein the container closure in terms of the mass of the container closure consists to a degree of 90% or more, preferably to a degree of 95% or more, particularly preferably to a degree of 98% or more, most particularly preferably substantially completely, of a first thermoplastic plastics material. Additionally or alternatively, a sealant system according to the invention is preferred, wherein the sealant container in terms of the mass of the sealant container consists to a degree of 90% or more, preferably to a degree of 95% or more, particularly preferably to a degree of 98% or more, most particularly preferably substantially completely, of a second thermoplastic plastics material. An example is, for example, a sealant system according to the invention, wherein the first thermoplastic plastics material is selected from the group comprising polyesters and polyolefins, preferably selected from the group comprising polyolefins, particularly preferably selected from the group comprising polyethylene and polypropylene, most particularly preferably selected from the group comprising polypropylene. An example is also a sealant system according to the invention, wherein the second thermoplastic plastics material is selected from the group comprising polyesters and polyolefins, preferably selected from the group comprising polyolefins, particularly preferably selected from the group comprising polyethylene and polypropylene, most particularly preferably selected from the group comprising polypropylene.

The invention also relates to a container closure for closing a container opening of a sealant container, which lies at the end of a container neck, wherein disposed on the container neck is an encircling first fastening elevation, wherein the first fastening elevation tapers in the direction of the container opening, in a sealant system according to the invention,
wherein the container closure comprises a first fluid channel extending through the container closure, and a second fluid channel extending through the container closure, wherein the container closure comprises a fastening region;
wherein disposed on the fastening region is an encircling second fastening elevation, wherein the second fastening elevation tapers in a pressing direction A;
wherein the container closure is specified in such a way that the container closure can be disposed on the container opening by pressing the container closure along the pressing direction A onto a sealant container, thereby at least partially elastically deforming the fastening region and/or the container neck; and
wherein the container closure is specified in such a way that, when disposing the container closure on the container opening, a form-fitting connection is caused by the mutual engagement of the first fastening elevation and the second fastening elevation.

Disclosed is moreover a method for producing a sealant system according to the invention or a container closure according to the invention, comprising the following method steps:
i) producing or providing a first thermoplastic plastics material; and
ii) molding the container closure blank from the first thermoplastic plastics material in a casting method;
wherein the fastening region in method step ii) is molded as part of the container closure blank.

The method for producing the sealant system according to the invention or the container closure according to the invention comprises in a first method step producing or providing a first thermoplastic plastics material, and in a second method step molding the container closure blank from this first thermoplastic plastics material in a casting method, wherein various casting methods are known to the person skilled in the art. An example is a method as disclosed above, wherein the casting method is an injection-molding method.

Also disclosed in the context of the invention is a breakdown assistance set comprising:
aa) one or a plurality of sealant systems as claimed in claim 1, comprising in the container interior a sealant; and
bb) a pressure generation unit.

In accordance with the understanding of a person skilled in the art, a breakdown assistance set is understood to be a kit consisting of a plurality of units which when used can enable the at least temporary sealing of a defective vehicle tire. In this context, a vehicle having a defect repaired by the breakdown assistance set can for example continue to travel independently at least for some time in order to be able to find a repair shop for replacing or repairing the respective vehicle tire, for example, as a result of which the requirement of a tow truck service is in particular dispensed with. For this purpose, the breakdown assistance set comprises at least one sealant system according to the invention having sealant, and a pressure generation unit. A breakdown assistance set as disclosed above is relevant for most of the applications, wherein the pressure generation unit is a compressed air compressor.

In order to connect the pressure generation unit to the at least one sealant system, and in order to connect the sealant system to the object to be sealed, fluid lines such as connection hoses, for example, are typically used in practice. Accordingly, a breakdown assistance set as disclosed above is expedient for most embodiments, said breakdown assistance set additionally comprising:
cc) one or a plurality of fluid lines, preferably hoses, for connecting the sealant system to a vehicle tire and/or the pressure generation unit.

Likewise, a breakdown assistance set as disclosed above is expedient in practice, said breakdown assistance set additionally comprising:
dd) an operating manual for sealing a damaged vehicle tire using the breakdown assistance set.

Also disclosed is a method for sealing a damaged vehicle tire using a breakdown assistance set as claimed in claim 3, comprising the following method steps:
v) producing a fluid-conducting connection between the first fluid channel and the pressure generation unit;
w) producing a fluid-conducting connection between the second fluid channel and the pressure valve of the damaged vehicle tire; and
z) discharging the sealant from the sealant system through the second fluid channel into the damaged vehicle tire.

Preferred embodiments of the invention will be explained and described in more detail hereunder with reference to the appended figures. In the figures:

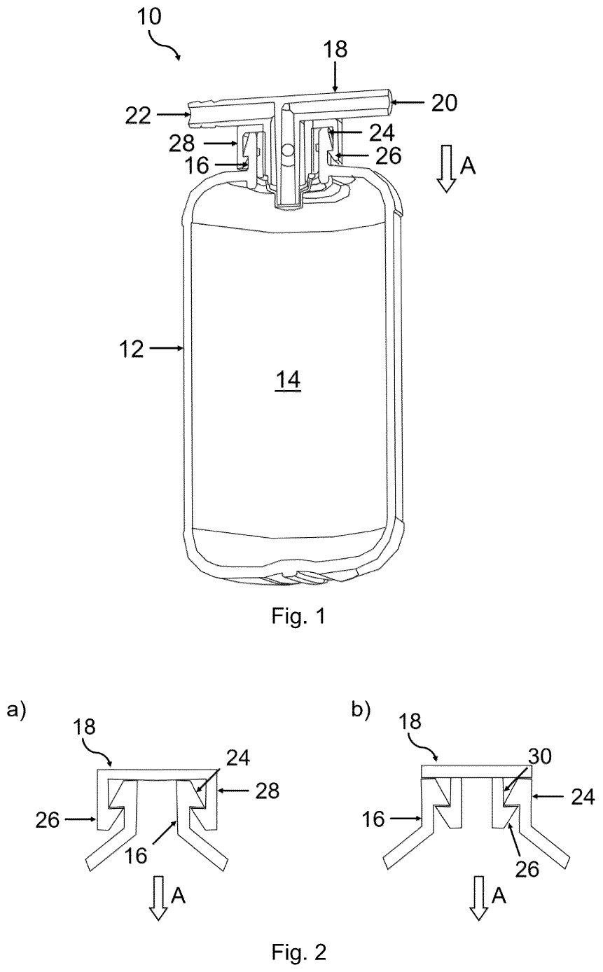

FIG. 1 shows a schematic cross-sectional illustration of a sealant system according to the invention in a preferred embodiment; and

FIG. 2 shows a highly simplified schematic illustration of different form-fitting connections between the container closure and the container neck of a sealant system according to the invention.

FIG. 1 shows a sealant system 10 according to the invention, having a sealant container 12 and a container closure 18 which is provided for the “upside down” use when sealing vehicle tires. In the example shown, the sealant container 12 as well as the container closure 18 are made completely of polypropylene.

The sealant container 12 has a container interior 14 having a volume of 450 ml in which a sealant can be received in a fluid-tight manner. The container interior 14 is accessible by way of a container opening which lies at the end of a container neck 16 and is closed by the container closure 18.

For guaranteeing the functionality required in the provision of a sealant for sealing methods, the container closure 18 moreover has a first fluid channel 20 and a second fluid channel 24. In the initial state, both fluid channels are closed in a fluid-tight manner by sealing elements, so that a sealant disposed in the container interior 14 cannot exit the sealant system 10 without an external force acting thereon, until the sealing elements are opened during the sealing method. The fluid channels are disposed in the container closure 18 so as to be mutually coaxial and separated from one another in portions, so that a direct fluid flow between the first fluid channel 20 and the second fluid channel 22 is not possible.

For producing the form-fit, the container neck 16 comprises a continuous encircling first fastening elevation 24, i.e. a convexity, so to speak, which tapers in the direction of the container opening. In contrast, the fastening region of the container closure 18 has a fastening collar 28 on which is disposed a continuous encircling second fastening elevation 26. The encircling second fastening elevation 26 tapers along the pressing direction A, which is illustrated as a directional arrow in FIG. 1. Both fastening elevations have a wedge-shaped cross section, wherein the triangular cross section has in each case an angle of 90° between the side facing away from the taper and the side resting on the respective component, wherein the height of the side facing away from the taper is in each case substantially identical.

The closure of the components in the example shown is produced in that a form-fitting connection is caused by the mutual engagement of the first fastening elevation 24 and the second fastening elevation 26. In other words, by attaching and pressing the container closure 18, the second fastening elevation 26 slides over the first fastening elevation 24 on the container neck 16, and latches therebehind. The fastening collar 28 herein has thinner walls and a larger radius than the container neck 16, so that the form-fit in the example shown takes place above all by a substantially completely elastic deformation of the fastening region 28 of the container closure 18. Due to the latching mechanism, releasing the container closure 18 is heavily impeded, or possible only by applying a significant force, the latter in addition to the conventional muscle force of a user in most instances requiring further aids and being in most instances associated with irreversible damage to the components.

In order to obtain a particularly fluid-tight closure, a sealing element is additionally disposed between the container closure 18 and the container neck 16 (not shown) so as to compensate for production-related tolerances when positioning the container closure 18 over the container neck 16.

Shown in FIGS. 2a) and 2b) are different embodiments of the form-fitting connection between the container closure 18 and the container neck 16, wherein the container closure for reasons of clarity is in each case highly schematic, so that the fluid channels are not plotted, for example. In a manner analogous to FIG. 1, FIG. 2a) shows a cross-sectional illustration through a container closure 18 having an encircling fastening collar 28 on which the second fastening elevation 26 is disposed so as to be radially inside, so that a sleeve-type shape is created. In a complementary manner, the first fastening elevation 24 is disposed radially outside on the container neck 16, so that a form-fit between the fastening elevations can be achieved when the container closure 18 is attached to the container neck 16.

In contrast, FIG. 2b) shows a container closure 18 having a central fastening plug 30 on which the second fastening elevation 26 is disposed so as to be radially outside, so that a cork-type shape is created. The first fastening elevation 24 in this embodiment is disposed radially outside on the container neck 16, so that a form-fit between the fastening elevations can be achieved when the container closure 18 is inserted into the container neck 16.

In both embodiments of FIG. 2, the extraction pressure P₂ which would be required for removing the container closure 18 from the container neck 16 is significantly higher than the pushing pressure P₁ which is required for obtaining the form-fit between the first fastening elevation 24 and the second fastening elevation 26.

### LIST OF REFERENCE SIGNS

10 Sealant system
12 Sealant container
14 Container interior
16 Container neck
18 Container closure
20 First fluid channel
22 Second fluid channel
24 First fastening elevation
26 Second fastening elevation
28 Fastening collar
30 Fastening plug
A Pressing direction

1. A sealant system comprising:
a) a sealant container comprising a container interior for receiving sealant, wherein the container interior is accessible by way of a container opening lying at the end of a container neck; and
b) a container closure wherein the container closure comprises a first fluid channel extending through the container closure, and a second fluid channel extending through the container closure, wherein the container closure comprises a fastening region;
wherein disposed on the container neck is an encircling first fastening elevation, wherein the first fastening elevation tapers in the direction of the container opening;
wherein disposed on the fastening region is an encircling second fastening elevation, wherein the second fastening elevation tapers in a pressing direction A;
wherein the sealant system is specified in such a way that the container closure can be disposed on the container opening by pressing the container closure along the pressing direction A onto the sealant container, thereby at least partially elastically deforming the fastening region and/or the container neck; and
wherein the sealant system is specified in such a way that, when disposing the container closure on the container opening, a form-fitting connection is formed by the mutual engagement of the first fastening elevation and the second fastening elevation.

2. The sealant system as claimed in claim 1, wherein the fastening region comprises an encircling fastening collar, wherein the encircling second fastening elevation is disposed on the fastening collar, and/or wherein the fastening region comprises a central fastening plug, wherein the encircling second fastening elevation is disposed on the fastening plug.

3. The sealant system as claimed in claim 1, wherein the first fastening elevation is disposed on the radially outer side of the container neck, and wherein the second fastening elevation is disposed on the radially inner side of the fastening region.

4. The sealant system as claimed in claim 1, wherein the first fastening elevation is disposed on the radially inner side of the container neck, and wherein the second fastening elevation is disposed on the radially outer side of the fastening region.

5. The sealant system as claimed in claim 1, wherein the first fastening elevation has a triangular cross section, wherein the triangular cross section on the side that faces away from the taper and rests on the container neck preferably has an angle in the range from 80° to 135°.

6. The sealant system as claimed in claim 1, wherein the second fastening elevation has a triangular cross section, wherein the triangular cross section between the side that faces away from the taper and the side that rests on the fastening region preferably has an angle in the range from 80° to 135°.

7. The sealant system as claimed in claim 1, wherein the sealant system is specified in such a way that the first fastening elevation and the second fastening elevation can slide past one another when pressing the container closure along the pressing direction A onto the sealant container when using a pushing pressure P1 and that, as a consequence of the mutual engagement of the first fastening elevation and the second fastening elevation, a form-fitting connection is caused, in which the first fastening elevation and the second fastening elevation cannot slide past one another when using an extraction pressure P2, wherein the extraction pressure P2 is higher than the pushing pressure P1.

8. The sealant system as claimed in claim 16, additionally comprising in the container interior a sealant.

9. The sealant system as claimed in claim 1, wherein the container closure in terms of the mass of the container closure consists to a degree of 90% or more of a first thermoplastic plastics material.

10. A container closure for closing a container opening of a sealant container, which lies at the end of a container neck, wherein disposed on the container neck is an encircling first fastening elevation, wherein the first fastening elevation tapers in the direction of the container opening, in a sealant system as claimed in claim 1,
wherein the container closure comprises a first fluid channel (20) extending through the container closure, and a second fluid channel extending through the container closure, wherein the container closure comprises a fastening region;
wherein disposed on the fastening region is an encircling second fastening elevation, wherein the second fastening elevation tapers in a pressing direction A;
wherein the container closure is specified in such a way that the container closure can be disposed on the container opening by pressing the container closure along the pressing direction A onto a sealant container, thereby at least partially elastically deforming the fastening region and/or the container neck; and wherein the container closure is specified in such a way that, when disposing the container closure on the container opening, a form-fitting connection is caused by the mutual engagement of the first fastening elevation and the second fastening elevation.
